(19) United States
(12) Patent Application Publication
(10) Pub. No.: US 2024/0402407 A1
(43) Pub. Date: Dec. 5, 2024

(54) META-MATERIAL INTERFEROMETRY SYSTEMS AND METHODS

(71) Applicants: Danbury Mission Technologies, LLC, Danbury, CT (US); Research Foundation of the City University of New York, New York, NY (US)

(72) Inventors: Alexander J. Majewski, Fairfield, CT (US); Andrea Alu, Tenafly, NJ (US); Adam C. Overig, Bronx, NY (US); Shuwei Guo, New York, NY (US)

(21) Appl. No.: 18/679,922

(22) Filed: May 31, 2024

Related U.S. Application Data
(60) Provisional application No. 63/470,048, filed on May 31, 2023.

(51) Int. Cl. G02B 5/30; G01B 9/02; G02B 1/00

(52) U.S. Cl. CPC G02B 5/3083; G01B 9/02049; G02B 1/00

(57) ABSTRACT

Optical systems include a first optical element featuring a first substrate, a partially-reflective coating disposed on a first surface of the first substrate, a first meta-material layer positioned on or adjacent to a first surface of the first substrate and including a structure that defines a continuous phase gradient along a first direction parallel to the first surface of the first substrate, and a second optical element featuring a second substrate and a second meta-material layer positioned on or adjacent to a first surface of the second substrate and comprising a structure that defines a continuous phase gradient along a second direction parallel to the first surface of the first substrate, where at least one surface of the second optical element is curved along the second direction.

### CROSS-REFERENCE TO RELATED APPLICATIONS

This application claims priority to U.S. Provisional Application No. 63/470,048, filed on May 31, 2023, the entire contents of which are incorporated herein by reference.

### TECHNICAL FIELD

This disclosure relates to the manipulation, spatial dispersion, and detection of light of different wavelengths.

### BACKGROUND

Optical waveforms that include a band of frequency components are widely used in applications involving signal transmission, metrology, communication, and spectroscopy. In the frequency domain, different frequency components of an optical waveform can be separated spatially using dispersive optical elements such as prisms and gratings to permit measurement and manipulation of individual components of the waveform. Perturbations among different frequency components can be measured using techniques such as interferometry, which can use these dispersive optical elements to generate interference among different frequency components of an optical waveform.

### SUMMARY

This disclosure features optical elements, systems and methods for interferometry and other applications involving detection and manipulation of frequency components of optical waveforms. The optical elements include one or more meta-material layers that define phase gradients along at least one direction of the layers, thereby functioning as dispersive components that cause different frequency components of an optical waveform to be spatially separated. The optical elements can be implemented in the form of a wedge or prism and integrated into optical systems. For example, in some embodiments, the optical elements function as (or are part of a system that functions as) a Fizeau interferometer. Optical elements and systems can include multiple meta-material layers to increase the spatial dispersion of frequency components of an optical waveform, and an input optical waveform can make multiple passes through one or more meta-material layers to enhance spatial dispersion of frequency components and measurement sensitivity.

A number of important advantages arise from implementing Fizeau interferometers with meta-material-based optical elements. In conventional Fizeau interferometry, a carefully calibrated glass wedge or prism is used to disperse frequency components, and the fidelity of the dispersion (and therefore the sensitivity of interferometry measurements) depends in part on the orientational precision of the angled surfaces of the wedge. For an imperfect wedge, measurement signals may depend on the position of the optical waveform as it is incident on the angled wedge surfaces. A Fizeau interferometer in which the dispersive element is an optical element with one or more meta-material layers can be implemented without using a wedge or prism, and is therefore not subject to measurement uncertainties which may arise from the relative position of an incident optical waveform.

Further, by using one or more meta-material layers as an alternative to surfaces that intersect at a wedge angle for dispersion, the free spectral range of the interferometer can be maintained over a relatively large area. The meta-material layers can be fabricated as planar layers, allowing for a very large free spectral range. In addition, because meta-materials can be fabricated at nanometer length scales, the dispersive properties of the meta-material layers can be tuned for specific applications involving particular wavelength bands.

In one aspect, the disclosure features optical systems that include: a first optical element featuring a first substrate, a partially-reflective coating disposed on a first surface of the first substrate, a first meta-material layer positioned on or adjacent to a first surface of the first substrate and including a structure that defines a continuous phase gradient along a first direction parallel to the first surface of the first substrate, where a change in magnitude of the phase along the first direction is at least 2Ξ at a wavelength Σ, and a partially-reflective layer disposed on or adjacent to the first meta-material layer and on an opposite side of the meta-material layer from the first substrate; and a second optical element featuring a second substrate, and a second meta-material layer positioned on or adjacent to a first surface of the second substrate and including a structure that defines a continuous phase gradient along a second direction parallel to the first surface of the first substrate, where the first and second optical elements are oriented so that the first and second directions are approximately orthogonal, and where at least one surface of the second optical element is curved along the second direction.

Embodiments of the optical systems can include any one or more of the following features.

The change in magnitude of the phase along the first direction can be at least 2Ξ at a wavelength Σ of between 0.8 μm and 1.8 μm. The first substrate can be formed from at least one material selected from the group consisting of SiO₂, Al₂O₃, and ZnS. The partially-reflective coating can include Si. The partially-reflective coating can have a reflectivity of between 20% and 50% at the wavelength Σ (e.g., between 25% and 35% at the wavelength Σ).

The continuous phase gradient along the first direction can extend for a distance of at least 1 mm along the first direction (e.g., for a distance of at least 2 mm along the first direction). The continuous phase gradient along the first direction can be a linear phase gradient. A portion of the continuous phase gradient along the first direction can be a linear phase gradient.

The partially-reflective layer can be a coating disposed on a surface of the first meta-material layer. The partially-reflective layer can include a third meta-material layer different from the first meta-material layer. The third meta-material layer can contact the first meta-material layer. The third meta-material layer can be disposed on a third substrate different from the first substrate. The third substrate can be positioned relative to the first substrate such that the first and third meta-material layers are in contact.

The third substrate can be positioned relative to the first substrate such that a gap is located between the first and third meta-material layers. The gap can be at least partially filled with air. At least one additional layer can be positioned in the gap. The at least one additional layer can include a solid material. The at least one additional layer can include an index matching layer with an index of refraction at the wavelength Σ that is between an index of refraction of the first meta-material layer at the wavelength Σ and an index of refraction of the third meta-material layer at the wavelength Σ.

The optical systems can include an anti-reflection coating disposed on a second surface of the first substrate opposite the first surface. The anti-reflection coating can have a reflectivity of 5% or less at the wavelength Σ.

The partially-reflective coating, the first meta-material layer, and the partially-reflective layer can define an optical cavity, and a finesse of the optical cavity can be at least 2 (e.g., at least 3, at least 10). A transmission efficiency for the optical system can be at least 70% (e.g., at least 80%).

The first meta-material layer can be positioned on or adjacent to a first region of the first surface of the first substrate, and an aperture that is free of the first meta-material layer can be positioned on or adjacent to a second region of the first surface of the first substrate, where the first and second regions of the first surface of the first substrate do not overlap. The partially-reflective coating may not be disposed in the second region of the first surface that forms the aperture. The partially-reflective layer may not be disposed on or adjacent to the second region of the first surface that forms the aperture.

At least one member of the group consisting of the partially-reflective coating, the first meta-material layer, and the partially-reflective layer can include a fiducial marker.

The first meta-material layer can include a plurality of repeating structures formed of a first material and embedded in a second material. The first material can include Si. The first material can include TiO₂. The plurality of repeating structures can include cylindrical structures. The plurality of repeating structures can include rectangular prismatic structures.

An average height of the repeating structures in the first meta-material layer, measured in a direction orthogonal to the first surface of the first substrate, can be between 0.2 μm and 1.5 mm (e.g., between 0.5 μm and 1.0 mm). An average maximum cross-sectional dimension of the repeating structures in the first meta-material layer, measured in a direction parallel to the first surface of the first substrate, can be between 50 nm and 1 mm (e.g., between 200 nm and 600 nm). An index of refraction at the wavelength Σ of the first material can be between 3.0 and 4.0. An index of refraction at the wavelength Σ of the second material can be between 1.0 and 2.0. A difference between indices of refraction of the first and second materials at the wavelength Σ can be between 1.5 and 2.5.

The second material can include at least one material selected from the group consisting of glass, fused silica, quartz, and sapphire. The second material can include at least one polymer material. The at least one polymer material can be selected from the group consisting of polymethylmethacrylate (PMMA), polycarbonate (PC), polystyrene (PS), polyester (PE), and cyclic olefin polymers (COP).

The plurality of repeating structures can be a first plurality of repeating structures and the first meta-material layer can include a second plurality of repeating structures formed of the first material and embedded in the second material, and the second plurality of repeating structures can be different from the first plurality of repeating structures. The second plurality of repeating structures can have a different cross-sectional shape than the first plurality of repeating structures. An average height of the second plurality of repeating structures, measured in a direction orthogonal to the first surface of the first substrate, can differ from an average height of the first plurality of repeating structures measured in the direction orthogonal to the first direction. An average maximum dimension of the second plurality of repeating structures, measured in a direction parallel to the first surface of the first substrate, can differ from an average maximum dimension of the first plurality of repeating structures measured in the direction parallel to the first surface of the first substrate.

The first meta-material layer can include a plurality of repeating structures formed of a third material and embedded in the second material, and the third material can be different from the first material. The third material can include at least one material selected from the group consisting of Si and TiO₂. The plurality of repeating structures formed of the first material and the plurality of repeating structures formed of the third material can have a common cross-sectional shape. Alternatively, the plurality of repeating structures formed of the first material and the plurality of repeating structures formed of the third material can have a different cross-sectional shape.

An average height of the plurality of repeating structures formed of the first material, measured in a direction orthogonal to the first surface of the first substrate, can be the same as an average height of the plurality of repeating structures formed of the third material, measured in the direction orthogonal to the first surface of the first substrate. The plurality of repeating structures formed of the first material can have an average height, measured in a direction orthogonal to the first surface of the first substrate, that differs from an average height of the plurality of repeating structures formed of the third material, measured in the direction orthogonal to the first surface of the first substrate.

An average maximum dimension of the plurality of repeating structures formed of the first material, measured in a direction parallel to the first surface of the first substrate, can be same as an average maximum dimension of the plurality of repeating structures formed of the third material, measured in the direction parallel to the first surface of the first substrate. The plurality of repeating structures formed of the first material can have an maximum dimension, measured in a direction parallel to the first surface of the first substrate, that differs from an average maximum dimension of the plurality of repeating structures formed of the third material, measured in the direction parallel to the first surface of the first substrate.

The second optical element can be a lens. The second optical element can be a cylindrical lens. The second optical element can be a lens selected from the group consisting of a plano-convex lens, a plano-concave lens, a biconvex lens, a biconcave lens, and a convex-concave lens. The second optical element can be a transmissive lens. The second optical element can be a reflective lens.

The at least one surface of the second optical element can be curved along both the first and second directions. A curvature of the at least one surface of the second optical element along the second direction can be aspherical. A curvature of the at least one surface of the second optical element along the second direction can be at least partially spherical. A curvature of the at least one surface of the second optical element along the second direction can be at least partially parabolic. A curvature of the at least one surface of the second optical element along at least one of the first and second directions can be aspherical. A curvature of the at least one surface of the second optical element along at least one of the first and second directions can be at least partially spherical. A curvature of the at least one surface of the second optical element along at least one of the first and second directions can be at least partially parabolic. A curvature of the at least one surface of the second optical element along the first direction can differ from a curvature of the at least one surface of the second optical element along the second direction.

The change in magnitude of the phase along the second direction can be at least 2Ξ at a wavelength Σ of between 0.8 μm and 1.8 μm. The second substrate can be formed from at least one material selected from the group consisting of SiO₂, Al₂O₃, and ZnS.

The continuous phase gradient along the second direction can extend for a distance of at least 1 mm along the second direction (e.g., at least 2 mm along the second direction). The continuous phase gradient along the second direction can be a linear phase gradient. A portion of the continuous phase gradient along the second direction can be a linear phase gradient.

The second meta-material layer can include a plurality of repeating structures formed of a first material and embedded in a second material. The first material can include Si. The first material can include TiO₂.

The plurality of repeating structures can include cylindrical structures. The plurality of repeating structures can include rectangular prismatic structures. An average height of the repeating structures in the second meta-material layer, measured in a direction orthogonal to the first surface of the second substrate, can be between 0.2 μm and 1.5 mm (e.g., between 0.5 μm and 1.0 mm). An average maximum cross-sectional dimension of the repeating structures in the second meta-material layer, measured in a direction parallel to the first surface of the second substrate, can be between 50 nm and 1 mm (e.g., between 200 nm and 600 nm).

An index of refraction at the wavelength Σ of the first material can be between 3.0 and 4.0. An index of refraction at the wavelength Σ of the second material can be between 1.0 and 2.0. A difference between indices of refraction of the first and second materials at the wavelength Σ can be between 1.5 and 2.5.

The second material can include at least one material selected from the group consisting of glass, fused silica, quartz, and sapphire. The second material can include at least one polymer material. The at least one polymer material can be selected from the group consisting of polymethylmethacrylate (PMMA), polycarbonate (PC), polystyrene (PS), polyester (PE), and cyclic olefin polymers (COP).

The plurality of repeating structures can be a first plurality of repeating structures and the second meta-material layer can include a second plurality of repeating structures formed of the first material and embedded in the second material, and the second plurality of repeating structures can be different from the first plurality of repeating structures. The second plurality of repeating structures can have a different cross-sectional shape than the first plurality of repeating structures. An average height of the second plurality of repeating structures, measured in a direction orthogonal to the first surface of the second substrate, can differ from an average height of the first plurality of repeating structures measured in the direction orthogonal to the first direction. An average maximum dimension of the second plurality of repeating structures, measured in a direction parallel to the first surface of the second substrate, can differ from an average maximum dimension of the first plurality of repeating structures measured in the direction parallel to the first surface of the second substrate.

The second meta-material layer can include a plurality of repeating structures formed of a third material and embedded in the second material, and the third material can be different from the first material. The third material can include at least one material selected from the group consisting of Si and TiO₂.

The plurality of repeating structures formed of the first material and the plurality of repeating structures formed of the third material can have a common cross-sectional shape. Alternatively, the plurality of repeating structures formed of the first material and the plurality of repeating structures formed of the third material can have a different cross-sectional shape.

An average height of the plurality of repeating structures formed of the first material, measured in a direction orthogonal to the first surface of the second substrate, can be the same as an average height of the plurality of repeating structures formed of the third material, measured in the direction orthogonal to the first surface of the second substrate. The plurality of repeating structures formed of the first material can have an average height, measured in a direction orthogonal to the first surface of the second substrate, that differs from an average height of the plurality of repeating structures formed of the third material, measured in the direction orthogonal to the first surface of the second substrate.

An average maximum dimension of the plurality of repeating structures formed of the first material, measured in a direction parallel to the first surface of the second substrate, can be the same as an average maximum dimension of the plurality of repeating structures formed of the third material, measured in the direction parallel to the first surface of the second substrate. The plurality of repeating structures formed of the first material can have a maximum dimension, measured in a direction parallel to the first surface of the second substrate, that differs from an average maximum dimension of the plurality of repeating structures formed of the third material, measured in the direction parallel to the first surface of the second substrate.

Embodiments of the optical systems can also include any other features described herein, including any combination of features that are individually described in connection with different embodiments, unless expressly stated otherwise.

In another aspect, the disclosure features devices that include any of the optical systems described herein, where the optical systems include a plurality of first optical elements, where the first surface of the first substrate of each first optical element is positioned in a common plane so that the partially-reflective coatings, the first meta-material layers, and the partially-reflective layers of each first optical element collectively define a continuous optical cavity that extends in a direction parallel to the common plane, and where a change in magnitude of the phase along the continuous optical cavity is greater than 2Ξ at the wavelength Σ.

Embodiments of the devices can include one or more of the following features.

The change in magnitude of the phase can be greater than 8Ξ at the wavelength Σ. Each first optical element of the plurality of first optical elements can be the same. Alternatively, one or more of the plurality of first optical elements can differ from one or more others of the plurality of first optical elements.

The first meta-material layer of one or more of the plurality of first optical elements can differ from the first meta-material layer of one or more others of the plurality of first optical elements. The change in magnitude of the phase along the first direction for one or more of the plurality of first optical elements can differ from the change in magnitude of the phase along the first direction for one or more others of the plurality of first optical elements. The plurality of first optical elements can include at least four first optical elements.

Embodiments of the devices can also include any other features described herein, including any combination of features that are individually described in connection with different embodiments, unless expressly stated otherwise.

In a further aspect, the disclosure features devices that include any of the optical systems described herein, where the optical systems include a plurality of first optical elements, where the first surface of the first substrate of one or more of the plurality of first optical elements is displaced in a direction orthogonal to the first surface of the first substrate from the first surface of the first substrate of one or more others of the plurality of first optical elements so that the partially-reflective coatings, the meta-material layers, and the partially-reflective layers of the plurality of first optical elements define a plurality of optical cavities that are mutually displaced in the orthogonal direction, and where a collective change in magnitude of the phase among the optical cavities is greater than 2Ξ at the wavelength Σ.

Embodiments of the devices can include any one or more of the following features.

The first surfaces of the first substrates of at least some of the plurality of first optical elements can be positioned in a common plane so that the partially-reflective coatings, the meta-material layers, and the partially-reflective layers of the at least some of the plurality of first optical elements collectively define a continuous optical cavity that extends in a direction parallel to the common plane. The devices can include multiple continuous optical cavities each extending in a different plane, and each continuous optical cavity can be mutually displaced from other continuous optical cavities in the device. The collective change in magnitude of the phase among the optical cavities can be greater than 8Ξ at the wavelength Σ.

Each first optical element of the plurality of optical elements can be the same. Alternatively, one or more of the plurality of first optical elements can differ from one or more others of the plurality of first optical elements.

The meta-material layer of one or more of the plurality of first optical elements can differ from the meta-material layer of one or more others of the plurality of first optical elements. The change in magnitude of the phase along the first direction for one or more of the plurality of first optical elements can differ from the change in magnitude of the phase along the first direction for one or more others of the plurality of first optical elements. Each continuous optical cavity can include a change in magnitude of the phase along the continuous optical cavity, and the change in magnitude of the phase for one or more of the multiple continuous optical cavities can differ from the change in magnitude of the phase for one or more others of the multiple continuous optical cavities.

The plurality of first optical elements can include at least four first optical elements.

Embodiments of the devices can also include any other features described herein, including any combination of features that are individually described in connection with different embodiments, unless expressly stated otherwise.

In another aspect, the disclosure features methods for generating an output optical waveform that include providing any one of the optical systems described herein, generating an input optical waveform that includes multiple wavelength components, and transmitting the input optical waveform through the optical system to generate an output optical waveform, where at least some wavelength components of the input optical waveform make multiple passes through at least one meta-material layer of the optical systems during transmission through the optical systems, and where the output optical waveform includes wavelength components that are spatially separated.

Embodiments of the methods can include any one or more of the features described herein, including any combination of features that are individually described in connection with different embodiments, unless expressly stated otherwise.

In a further aspect, the disclosure features methods for generating an output optical waveform that include providing any one of the devices described herein, generating an input optical waveform that includes multiple wavelength components, and transmitting the input optical waveform through the device to generate an output optical waveform, where at least some wavelength components of the input optical waveform make multiple passes through at least one meta-material layer of the devices during transmission through the devices, and where the output optical waveform includes wavelength components that are spatially separated.

Embodiments of the methods can include any one or more of the features described herein, including any combination of features that are individually described in connection with different embodiments, unless expressly stated otherwise.

As used herein, the term “meta-material layer” refers to a planar or non-planar layer that includes a plurality of structures designed to interact with, and manipulate properties of, electromagnetic waves in a manner that does not occur naturally when the individual materials used to form the layer interact with such waves. In some embodiments, a meta-material layer can have one or more properties (such as a negative refractive index) that are not found in naturally occurring materials. A meta-material layer is generally formed by introducing structural elements into/onto a substrate. In certain embodiments, the introduced structural elements have a defined spatial periodicity within at least a portion of the layer, and the structural elements and substrate together form a composite material. Spatial periodicity can occur in one-, two-, and/or three-dimensions of the layer, and can be present (but is not always present) at dimensional scales that are smaller than the wavelengths with which they interact. Further, in some embodiments, the structural elements have regular geometric forms/shapes that can include (but are not limited to) cylindrical, rectangular prismatic, triangular prismatic, cones, helices, and extruded volumetric structures derived from two-dimensional cross-sectional shapes such as crosses, polygons, and other regular geometric shapes. In certain embodiments, the structural elements can include apertures, channels, and/or other features that extend partially or completely through the elements.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the subject matter herein, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments are set forth in the accompanying drawings and the description below. Other features and advantages will be apparent from the description, drawings, and claims.

### DESCRIPTION OF DRAWINGS

FIG. 1 is a schematic diagram of a Fizeau interferometer.

FIG. 2 is a schematic diagram of an example of a meta-material-based interferometer.

FIG. 3 is a graph showing transmitted light intensity for a conventional Fabry-Perot etalon.

FIG. 4 is a schematic diagram of another example of a meta-material-based interferometer.

FIGS. 5A-5C are graphs showing calculated spatial fringe profiles for meta-material-based interferometers with different spacings between the meta-material layer and partially-reflective layer.

FIG. 6 is a graph of peak position for the fringes as a function of wavelength Σ and spacing between the meta-material layer and partially-reflective layer for the interferometer of FIG. 2.

FIGS. 7A-7C are graphs showing interference fringes calculated for the interferometers of FIGS. 5A-5C with different reflectivities of the meta-material layer and partially-reflective layer.

FIGS. 8A and 8B are top and side views of an example of a meta-material-based interferometer.

FIGS. 8C and 8D are graphs showing transmittance as a function of wavelength and position for the interferometer of FIGS. 8A and 8B, calculated using a plane wave approximation (FIG. 8C) and full-field simulation (FIG. 8D).

FIG. 9 is a graph of transmitted amplitude and phase for an optical waveform incident on an array of Si pillars.

FIGS. 10A-10D are graphs showing design parameters and error estimations for an example of a meta-material-based interferometer.

FIGS. 11A-11D are graphs showing design parameters and error estimations for another example of a meta-material-based interferometer.

FIG. 12A is a schematic diagram of an example meta-material-based interferometer.

FIGS. 12B-12E are optical and scanning electron microscope images of the interferometer of FIG. 12A.

FIGS. 13A-13D are images showing single wavelength and multi-wavelength fringes for example interferometers of different effective wedge angle and reflectivity.

FIGS. 14A-14G are graphs showing fringe patterns for the interferometer of FIG. 13C with an optical waveform incident at different angles along the phase gradient direction of the meta-material layer.

FIGS. 15A-15C are graphs showing fringe patterns for the interferometer of FIG. 13C with an optical waveform incident at different angles along a direction orthogonal to the phase-gradient direction of the meta-material layer.

FIG. 16 is a set of images showing measured fringes from a corrected interferometer at a single wavelength and multiple wavelengths.

FIG. 17A is a schematic diagram of an optical system that includes a meta-material-based interferometer and a meta-material-based lens.

FIG. 17B is a graph showing spatial dispersion and focusing of single-wavelength light by a meta-material-based lens.

FIG. 17C is a graph showing spatial dispersion and focusing of multi-wavelength light by a meta-material-based lens.

FIG. 17D is a graph showing spatial dispersion and focusing of nearly monochromatic light by a meta-material-based lens and interferometer to resolve small wavelength differences.

FIG. 17E is a graph showing spatial dispersion and focusing of polychromatic light by a meta-material-based lens and interferometer to resolve wavelength differences in two dimensions.

FIG. 17F is a graph showing the transmittance map of the device of FIG. 17A.

FIG. 18A is a schematic diagram of an optical device that includes a meta-material-based interferometer and meta-material-based prism.

FIG. 18B is a graph of an example transmission spectrum for the interferometer of the system of FIG. 18A.

FIG. 18C is a schematic diagram of another optical device that includes a meta-material-based interferometer and meta-material-based prism.

Like reference symbols in the various drawings indicate like elements.

### DETAILED DESCRIPTION

### I. Introduction

A wide variety of spectroscopy, metrology, and communications applications generate, detect, and measure optical waveforms that include light of different wavelengths. In many such applications, the frequency components of the optical waveform are dispersed spatially so that light of different wavelengths can be detected and/or manipulated. Optical elements that provide for spatial dispersion of different frequency components in an optical waveform include prisms, wedges, diffraction gratings, phase gratings, and other elements that introduce a frequency-dependent phase to an optical waveform that interacts with the element.

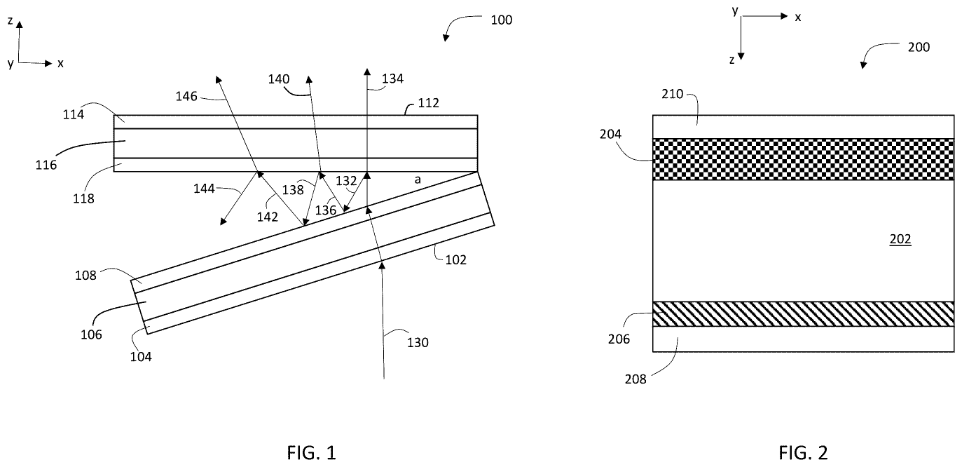

One example of a device that spatially disperses frequency components of an incident optical waveform is a Fizeau interferometer, which can function as a spectrometer or, more generally, a wavelength-dispersive component in a system that performs spectroscopic analysis or metrology operations (for example, surface profile measurements). FIG. 1 is a schematic diagram of an example of a Fizeau interferometer 100. The interferometer includes a first window 102 and a second window 112 oriented at a small angle α with respect to each other. First window 102 includes an antireflection coating 104, a substrate 106, and a partially reflective mirror layer 108. Similarly, second window 112 includes an antireflection coating 114, a substrate 116, and a partially reflective mirror layer 118.

When an optical waveform 130 is incident on first window 102, the optical waveform (nominally) passes through antireflection coating 104, substrate 106, and mirror layer 108, through the space between first window 102 and second window 112, and is incident on mirror layer 118. Because mirror layer 118 is partially reflective, a portion of waveform 130 is reflected from mirror layer 118 (as waveform 132) and a portion of waveform 130 is transmitted through mirror layer 118, substrate 116, and antireflection coating 114, and emerges from second window 112 as waveform 134.

Reflected waveform 132 reflects from mirror layer 108, and the reflected portion of waveform 132 (waveform 136) is incident on mirror layer 118, where a portion of waveform 136 is transmitted through second window 112 (as waveform 140) and a portion is reflected from mirror layer 118 (as waveform 138). A portion of waveform 138 is reflected from mirror layer 108 as waveform 142, which is then incident on mirror layer 118, and a portion of waveform 142 is transmitted through second window 112 as waveform 146 and a portion reflected from mirror layer 118 as waveform 144. The process repeats, generating additional waveforms transmitted through second window 112.

The lateral spacing between transmitted waveforms (e.g., 134, 140, and 146) in the x-direction depends on the angle of incidence of optical waveform 130 on first window 102, on the wavelength (or frequency) of optical waveform 130, and on the angle α between windows 102 and 112. Transmitted waveforms 134, 140, and 146 interfere beyond second window 112, generating a pattern of interference fringes that has a peak of maximum intensity at a particular location along the x-direction.

If optical waveform 130 contains only monochromatic light of a single wavelength, then a single fringe pattern is observed at a location along the x-direction that corresponds to the wavelength of the monochromatic light. However, if optical waveform 130 contains light of multiple wavelengths, then multiple fringe patterns corresponding to the wavelengths are observed, with the fringe pattern associated with each wavelength located at a different position along the x-direction. Effectively, windows 102 and 112 function as a plurality of Fabry-Perot etalons, and for an incident optical waveform 130 that includes multiple wavelengths of light (or, stated alternatively, multiple frequency components), the transmitted wavelengths of light interfere constructively at different locations along the x-direction, and are therefore dispersed spatially along the x-direction and can be detected and otherwise manipulated individually by positioning additional optical elements (e.g., detectors, modulators) at particular locations along the x-direction.

As noted above, however, the functioning of interferometer 100 depends significantly on a variety of geometric variables. These include the angle of incidence of optical waveform 130 on first window 102, the angle α between windows 102 and 112, the index of refraction of the medium in the gap between windows 102 and 112, and the geometric properties (and any imperfections) of windows 102 and 112. Accordingly, prior to use, interferometer 110 is typically carefully calibrated to ensure that the mapping of wavelength to position along the x-direction is determined with high fidelity. It can be difficult, however, to compensate for imperfections in windows 102 and 112 (e.g., surface abnormalities, a non-constant wedge angle α due to curvature of either or both of windows 102 and 112, deformations arising from temperature changes and/or mechanical perturbations). Moreover, the wedge angle α is typically not adjustable, as it can be challenging to maintain windows 102 and 112 in a fixed angular relationship over time.

This disclosure features optical elements, systems, and methods for performing spectral dispersion and wavelength resolution that rely on Fizeau-type interference without an optical wedge. More particularly, the optical elements include one or more meta-material layers that impart a phase offset to different wavelengths of a multi-wavelength optical waveform, so that the wavelengths of the optical waveform are dispersed spatially along a direction transverse to a direction of incidence of the multi-wavelength optical waveform.

### II. Dispersive Optical Elements

FIG. 2A is a schematic diagram of an example of a meta-material-based Fizeau interferometer 200. The interferometer includes a substrate 202, a meta-material layer 204, a partially-reflective layer 206, an optional anti-reflection layer 208, and another optional anti-reflection layer 210. It should be understood that interferometer 200 in FIG. 2A is merely an example, and other configurations are possible. For example, other functional layers may also be present in interferometer 200 in some embodiments, and certain layers (e.g., layers 208 and/or 210) may not be present in interferometer 200 in certain embodiments.

Substrate 202 is generally formed from one or more materials that are optically clear and allow light of particular wavelengths (e.g., wavelengths used for spectroscopic measurements, metrology, or other applications) to be transmitted without significant absorption. For purposes of this disclosure, “significant absorption” means the materials used in substrate 202 have a linear absorption coefficient of 0.1 cm⁻¹ or less.

A wide variety of materials can be used to fabricate substrate 202, depending upon the particular application in which interferometer 200 is used. For example, substrate 202 can be formed from materials such as SiO₂, Al₂O₃, and ZnS. Substrate 202 can be formed from a single material in some embodiments. Alternatively, in certain embodiments, substrate 202 can be formed from multiple, different materials, blended together in a homogeneous or heterogeneous mixture, or disposed in multiple layers, domains, or other structures within substrate 202.

Partially-reflective layer 206 allows a portion of a waveform that is incident on the layer to be reflected, and a portion to be transmitted through the layer. Layer 206 can be formed from a variety of different materials, depending upon the nature of the other layers in interferometer 200 and the wavelengths of light used in applications involving the interferometer. In some embodiments, for example, layer 206 is formed from Si. In certain embodiments, layer 206 is formed from one or more metals such as chromium, gold, and/or silver. In some embodiments, layer 206 is formed from one or more dielectric materials. Layer 206 can be formed from a single material, or from combinations of multiple materials.

Although layer 206 is shown in FIG. 2 as a homogeneous layer that includes one or more materials, in certain embodiments layer 206 can be implemented as a non-homogeneous layer. For example, layer 206 may include multiple layers of different materials (e.g., a layer stack in which the layers of different materials are adjacent). In some embodiments, layer 206 can be implemented by forming domains of one or more materials in a layer of another material, such that the domains effectively appear as joined or non-joined regions in a background of one or more other materials.

Layer 206 can be deposited on substrate 202 in various ways. In some embodiments, for example, layer 206 can be applied via chemical vapor deposition (CVD) or physical vapor deposition (PVD) in which one or more precursor materials are introduced into the gas phase, and allowed to deposit onto substrate 202 to form layer 206. In some embodiments, the thickness of layer 206 is controlled (e.g., by controlling the deposition time) to adjust the reflectivity of layer 206. In certain embodiments, layer 206 can be formed by sputtering one or more materials into the gas phase and allowing the sputtered atoms or ions to deposit onto substrate 202. In some embodiments, layer 206 can be formed by solid state methods. For example, the material(s) from which layer 206 is formed can be deposited directly on substrate 202 by a process such as solution based deposition, spin coating, and/or in situ chemical processes (e.g., polymerization).

Anti-reflection layers 208 and 210 can have the same or different compositions, thicknesses, and anti-reflection properties. In general, layers 208 are formed from one or more materials that reduce reflections arising from refractive index mismatches at the interfaces between these layers and other layers of interferometer 200. A variety of different materials can be used to form layers 208 and 210 including, but not limited to, MgF₂, CaF₂, quartz, SiO₂, polymer materials, and other crystalline and non-crystalline materials. Layers 208 and 210 can independently formed of a single material, or of multiple materials. If multiple materials are used, they may together form a homogeneous composite material, or they may be formed as a heterogeneous composite of domains of one material in another, or laminar layers of different materials, as described above in connection with layer 206. The reflectivity of each of layers 208 and 210 can generally be 0.10 or less (e.g., 0.08 or less, 0.05 or less, 0.03 or less, 0.02 or less, 0.01 or less, or even less).

In general, anti-reflection layers 208 and 210 can be formed by processes similar to those described above in connection with layer 206, such as (but not limited to) CVD, PVD, sputtering, and solid state physical and chemical deposition methods.

As discussed briefly above, in a conventional Fizeau interferometer, a wedge formed by two surfaces functions as, in effect, a continuous, adiabatically spatially varying Fabry-Perot etalon. In a conventional Fabry-Perot etalon, partial reflection of light from two closely-spaced surfaces leads to the light making multiple round trips between the surfaces before leaving the gap between the surfaces. Light is transmitted through the etalon if the round trip phase accumulation is an integer multiple of 2π, such that constructive interference occurs at the etalon output. Assuming no scattering or other losses, light is transmitted with unitary efficiency. When the phase condition is not satisfied, interference causes some or all of the light to be reflected. The round trip phase is largely a function of the phase imparted by the region between the etalon surfaces. Since the phase is dispersive with wavelength, the etalon transmits light only at specific wavelengths.

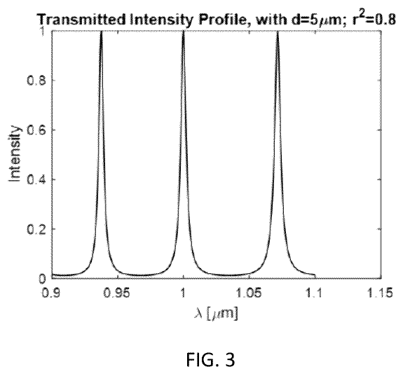

FIG. 3 is a graph showing transmitted light intensity for a conventional Fabry-Perot etalon with a spacing between etalon surfaces of 5 microns, and with each etalon surface having a reflectivity of 0.8. As is event from FIG. 3, only light at specific wavelengths Σ that satisfy the phase condition discussed above is transmitted through the etalon.

In a conventional Fizeau interferometer, because the two reflective surfaces of the wedge are oriented at an angle α, the phase condition described above is satisfied for different wavelengths Σ at different lateral positions in the x-coordinate direction. Consequently, a conventional wedge-based Fizeau interferometer functions as a dispersive component, with different wavelengths of light in an incident optical waveform transmitted through the interferometer at different positions along the x-coordinate direction.

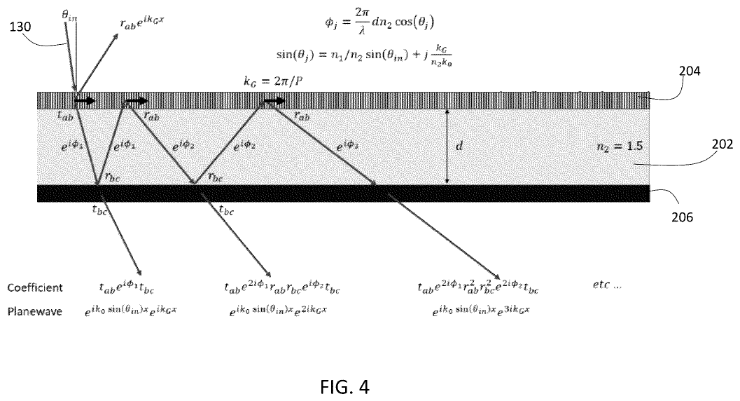

FIG. 4 is a schematic diagram showing certain features of interferometer 200, including substrate 202, meta-material layer 204, and partially-reflective layer 206. In interferometer 200, metal-material layer 204 produces a result similar to the wedge in a conventional Fizeau interferometer. Layer 204 introduces a phase gradient to anomalously reflect light. As shown in FIG. 4, an optical waveform 130 that is incident on the interferometer is transmitted through layer 204 and substrate 202. Each time the waveform encounters layer 206, a portion of the waveform is transmitted through layer 206 and a portion of the waveform is reflected through substrate 202. Each time the waveform passes through substrate 202, it accumulates an additional phase due to substrate 202 that depends on the thickness d of the substrate and its refractive index.

Further, each time the waveform reflects from meta-material layer 204 as shown in FIG. 4, the layer—which is a phase-gradient layer—imparts a momentum kick k_{G}=2π/P, where P is the super period of meta-material layer 204. The output from interferometer 200 can be modeled by adding plane waves (weighted by proper coefficients) transmitted through partially-reflecting layer 206 and corresponding to each round trip of the optical waveform between layers 204 and 206. As shown in FIG. 4, each of the weighted plane waves contains phase contributions from interaction with both substrate 202 and meta-material layer 204.

As further shown in FIG. 4, the phase accumulated by the waveform that is transmitted through layer 206 varies spatially. Consequently, interferometer 200 in FIG. 4 functions as a Fabry-Perot etalon in which each wavelength has a transmission peak (e.g., is transmitted through layer 206) at a particular position within the super period P of the meta-material layer 204. Because along the period P the meta-material layer 204 imparts every phase delay between 0 and 2π, at some position along the x-coordinate direction the interference condition described above will be satisfied for every wavelength Σ.

As noted above, the round trip phase accumulated by an optical waveform depends upon the thickness d of substrate 202 and the refractive index n₂ of the substrate. In general, the greater the thickness d, the larger the accumulated phase from each round trip of an optical waveform between layers 204 and 206. In turn, the magnitude of the phase accumulated from each round trip between layers 204 and 206 affects the spatial dispersion of wavelengths in the x-coordinate direction that emerge from interferometer 200.

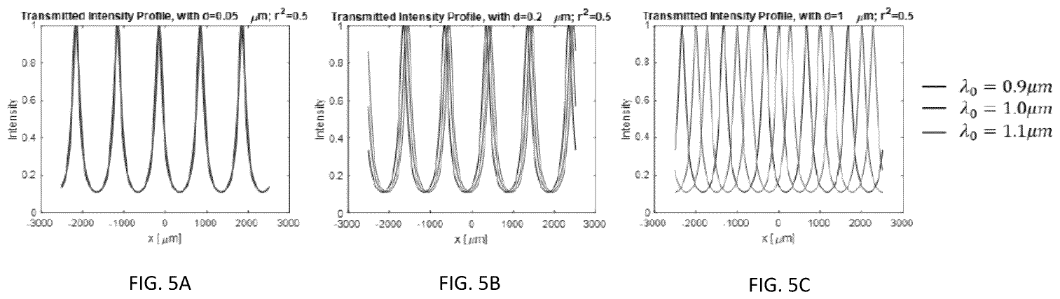

FIGS. 5A-5C are graphs showing calculated spatial fringe profiles for different thicknesses d (0.05 μm, 0.2 μm, and 1 μm) of substrate 202, and for three different wavelengths (0.9 μm, 1.0 μm, and 1.1 μm), with n₂=1.5. As indicated in FIGS. 5A-5C, interferometer 200 behaves in a manner similar to an etalon, with the periodic fringe positions at each wavelength shifting laterally (i.e., in the x-coordinate direction) as a function of wavelength. Notably, the lateral shift increases with increasing d. In FIGS. 5A-5C, the fringe pattern is periodic with period P, since it is calculated from a summation of weighted plane waves, as discussed above in connection with FIG. 4. For the graphs in FIGS. 5A-5C, the period P=1 mm.

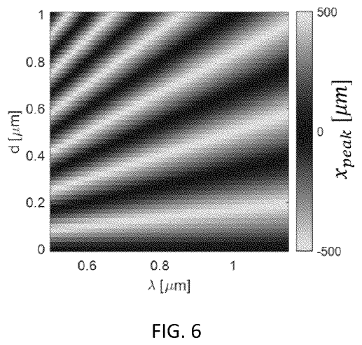

FIG. 6 is a graph of peak position for the fringes (modulo a period P) as a function of wavelength Σ and thickness d. The graph follows the analytical form:

$${x}_{peak} = mod ( - 2 {n}_{2} dP / \sum , P ) \qquad [ 1 ]$$

where xₚₑₐₖ is the peak intensity and the function mod (y,P) is defined as y modulo P.

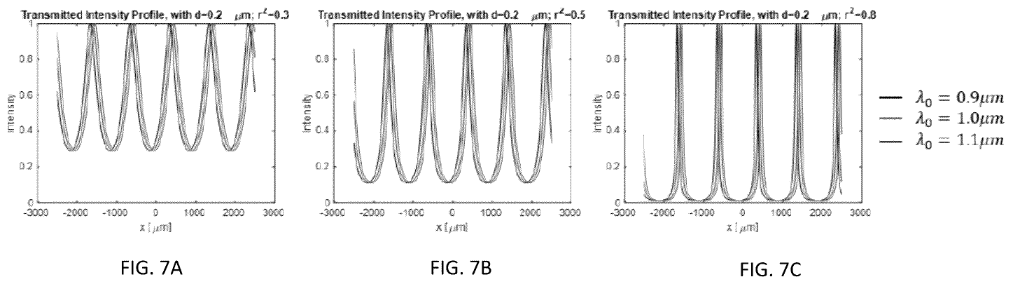

The graph in FIG. 6 was computed assuming that layers 204 and 206 have a reflectivity of 0.5. If the reflectivity of either or both layers increases, the fringes sharpen. FIGS. 7A-7C are graphs showing interference fringes calculated for a substrate 202 of thickness d=0.2 μm, for the same wavelengths as in FIGS. 5A-5C, with the reflectivity of layers 204 and 206 increasing from 0.3 (FIG. 7A) to 0.5 (FIG. 7B) and then further to 0.8 (FIG. 7C). As is evident from these figures, the fringes sharpen considerably as the reflectivity of layers 204 and 206 increases. A similar phenomenon occurs in a Fabry-Perot etalon, but whereas in the etalon the sharpening occurs due to spectral interference alone, in the examples of FIGS. 7A-7C, the increase in sharpening arises from, in effect, an increased “sensitivity” to the accumulated phase on each round trip of the optical waveform between layers 204 and 206. As a result, a narrower range of phases results in constructive interference between the round trips and the spatial distribution of each of the fringes becomes narrower (i.e., the peaks are “sharpened”).

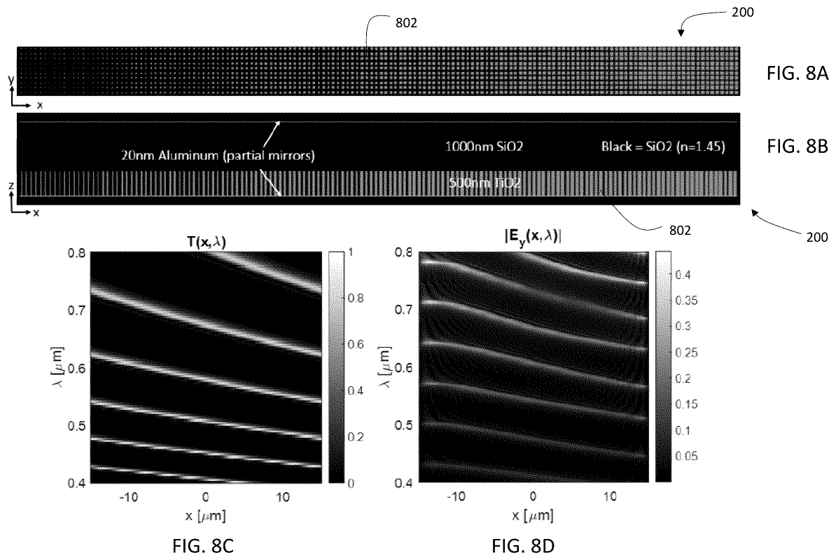

To further understand the effect of meta-material layer 204, consider the example interferometer 200 shown in FIGS. 8A and 8B. FIG. 8A is a schematic top view of the interferometer and FIG. 8B is a schematic side view of the interferometer. The interferometer includes a plurality of titania (TiO₂) pillars (with refractive index 2.5), each having the shape of a rectangular prism, embedded in a glass substrate. The pillars had a square cross-sectional shape (i.e., in the x-y plane) and a length in the z-coordinate direction of 500 nm. In the configuration shown in FIGS. 8A and 8B, any phase value between 0 and 2π can be imparted to an incident optical waveform.

FIG. 8C is a graph showing calculated transmittance through each position along the x-coordinate direction as a function of wavelength using the model of FIG. 4, which FIG. 8D is a graph showing a full-wave simulation conducted for the interferometer of FIGS. 8A and 8B. The two simulations show relatively close agreement, with the deviation between them largely attributable to the wavelength dependence of the phase profile of the meta-material layer 204.

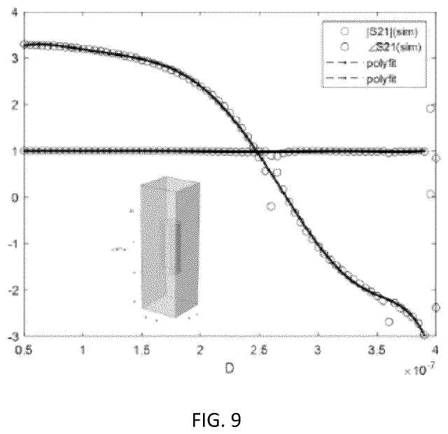

In general, the parameters of meta-material layer 204 can be adjusted based on a desired operating wavelength. As an example, a meta-material layer 204 was designed for use in the near-infrared spectral region. For a periodic array of cylindrical silicon pillars embedded in a lower refractive index (n=1.48) background PMMA material, with a lattice dimension of the unit cell of A=600 nm in both x- and y-coordinate directions, a silicon pillar height of 0.8 μm in the z-coordinate direction, a diameter D from 50 nm to 400 nm, and a refractive index of n=3.52 for Si at the central wavelength of 1.2 μm, the transmission coefficient of the unit cell is shown in the graph of FIG. 9. In FIG. 9, the straight line shows the transmitted amplitude, while the decaying line shows the transmitted phase through the array of silicon pillars.

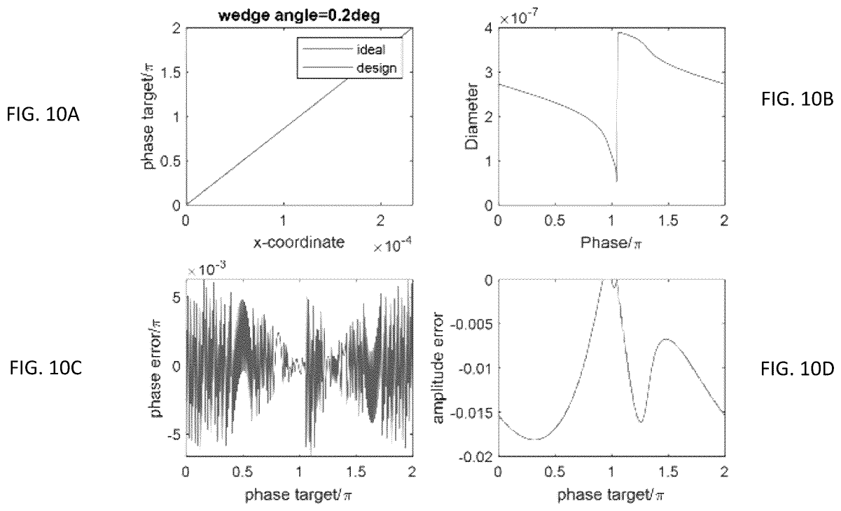

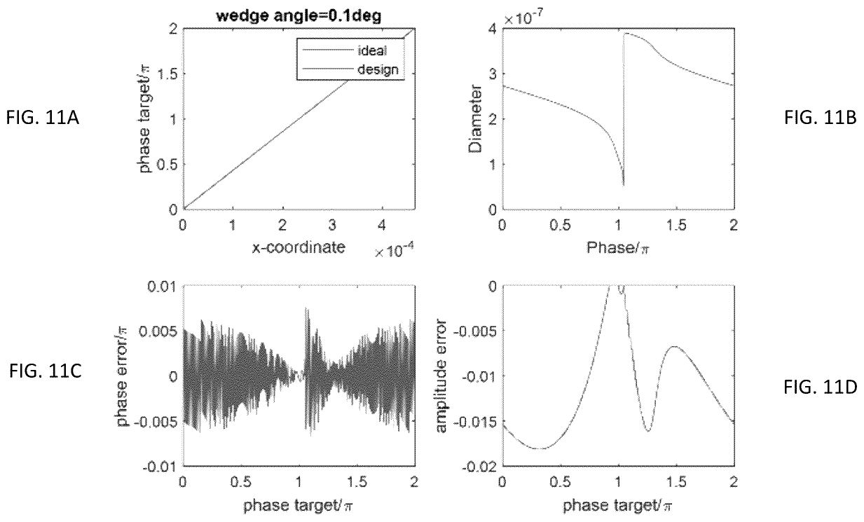

To mimic the functionality of a Fizeau interferometer with a wedge angle θ_{w}, the period length P of the meta-material layer 204 can be calculated as P=Σₒ/nθ_{w}, where Σₒ is the design wavelength (e.g., 1.2 μm) and n is the refractive index of the substrate material (e.g., 1.48 for PMMA), and θ_{w} is assumed to be relatively small. FIGS. 10A-10D are graphs showing design parameters and error estimations for a device with θ_{w}=0.2 degrees, and FIGS. 11A-11D are graphs showing design parameters and error estimations for a device with θ_{w}=0.1 degrees. The phase varies linearly from 0 to 2π across the period, and both devices have very small phase error (<1%) and amplitude error (<2%) across the entire period.

Referring again to FIGS. 2 and 4, interferometer 200 is shown operating in transmission mode; that is, the wavelength components of the optical waveform emerge from interferometer 200 in a direction that approximately corresponds to the direction of incidence of the optical waveform. Reflection layer 210 ensures that wavelength components are effectively reflected from meta-material layer 204 to achieve this output directionality. In some embodiments, however, interferometer 200 can operate in reflection mode, with wavelength components emerging from interferometer 200 in a direction that approximates reflection of the incident optical waveform from interferometer 200. For example, layer 210 can be implemented as a partially-reflective layer (e.g., similar to layer 206 described above), and layer 206 can be implemented as a reflective layer (e.g., similar to layer 210 described above). In this configuration, wavelength components that pass through meta-material layer 204 acquire a phase shift in a manner similar to the interaction between the optical waveform and meta-material layer 204 described previously.

In certain embodiments, the phase imparted to the optical waveform by meta-material layer 204 is polarization insensitive. In other words, optical waveforms that are polarized in either the S or P orientations (or a superposition thereof) will acquire the same phase shift when interacting with meta-material layer 204. In some embodiments, however, the phase imparted to the optical waveform by meta-material layer 204 is polarization-dependent. For example, meta-material layer 204 can be fabricated such that it implements a first phase pattern or gradient for an optical waveform polarized in a first linear direction (e.g., a P-polarized optical waveform), and a second phase pattern or gradient for an optical waveform polarized in a second linear direction (e.g., an orthogonal direction) relative to the first linear direction (e.g., an S-polarized optical waveform). An optical waveform that is linearly polarized in either the first or second directions will therefore be imparted a phase corresponding to the first or second phase pattern/gradient, respectively. An optical waveform that is linearly polarized in a direction intermediate between the first and second directions, or that has a circular or elliptical polarization, will be imparted a more complex overall phase that depends on the interaction between the polarization components of the optical waveform with the first and second phase patterns/gradients.

In general, meta-material layer 204 can be fabricated using a variety of techniques. In some embodiments, for example, meta-material layer 204 is fabricated using standard electron-beam lithography (EBL) techniques. Other methods that can be used for the fabrication of the meta-material layers described herein include, but are not limited to, nano-imprint lithography and photolithography.

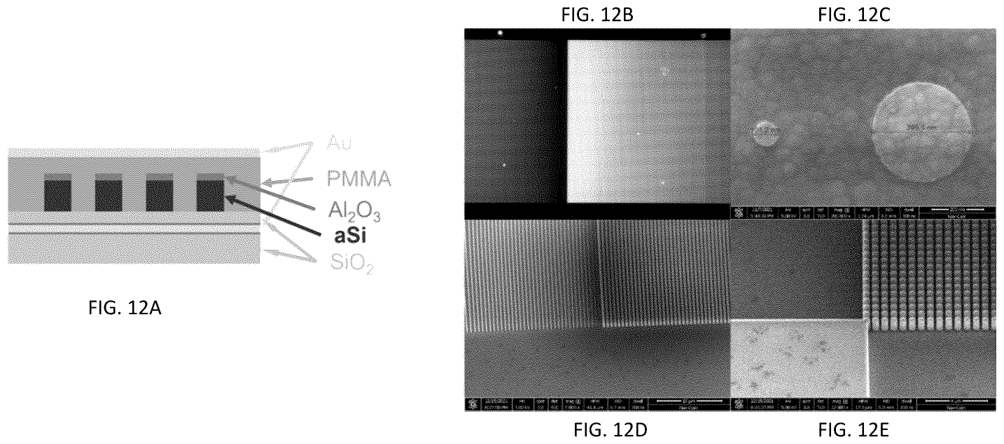

An example of a meta-material layer 204 is shown in FIG. 12A. To form the meta-material layer 204 (consisting of a plurality of Si pillars embedded in a PMMA matrix), an initial fabrication substrate consisting of a layer of SiO₂ with epitaxial layers of Au (as a partially-reflective layer) and SiO₂ was prepared. Next, pillars of Si were deposited on the fabrication substrate by masking the fabrication substrate and using EBL to selectively deposit Si in the unmasked regions. Inductively-coupled plasma (ICP) etching was used to ensure that the pillars were well separated with smooth sides. A thin epitaxial layer of Al₂O₃ was then applied atop each pillar, and the mask was removed from the fabrication substrate.

A layer of PMMA was then applied to encapsulate the Si pillars on the fabrication substrate using standard polymer deposition techniques, and a thin epitaxial layer of Au was applied atop the PMMA layer to function as a partially-reflective layer.

FIG. 12B is a microscope image showing the interferometer after the mask was removed from the fabrication substrate, and FIGS. 12C-12E are scanning electron microscope images of the Si pillars after ICP etching. As shown in these images, Si pillars were formed uniformly and precisely using the above process.

Interferometers fabricated using the above techniques were tested by positioning the interferometer to receive an optical waveform from a collimated laser source in the near infrared spectral region. A near-IR objective was used to focus light emerging from the interferometer onto a near-IR camera system that imaged the light from the interferometer.

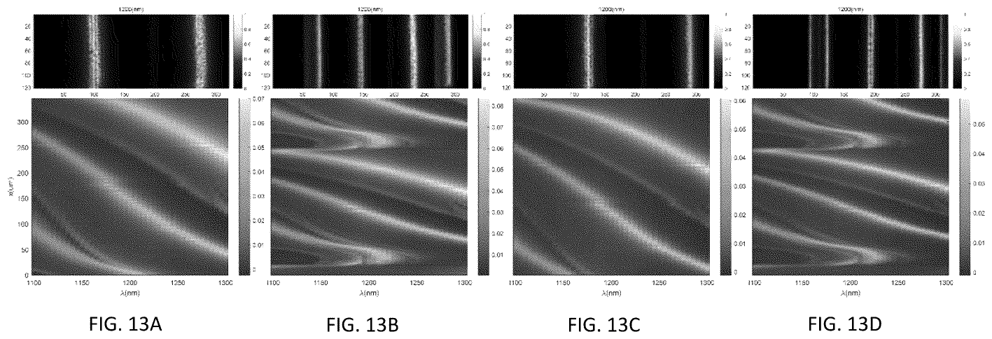

FIGS. 13A-13D are sets of images showing the spectral response of four different interferometers illuminated at normal incidence. In each of FIGS. 13A-13D, the upper image shows the image captured at a wavelength of 1.2 μm, and the lower image shows spectral fringes measured for wavelengths from 1.1 μm to 1.3 μm. The interferometers in FIGS. 13A and 13C had effective wedge angles of 0.1 degrees, while the interferometers in FIGS. 13B and 13D had effective wedge angles of 0.2 degrees. Notably, the larger effective wedge angles yield a more compact fringe pattern, while the free spectral range remains largely the same. The reflectivity of the partially-reflective layer is lower in FIGS. 13A and 13C than in FIGS. 13B and 13D. As discussed above, the sharpness of the interference fringes generally increases with an increase in reflectivity.

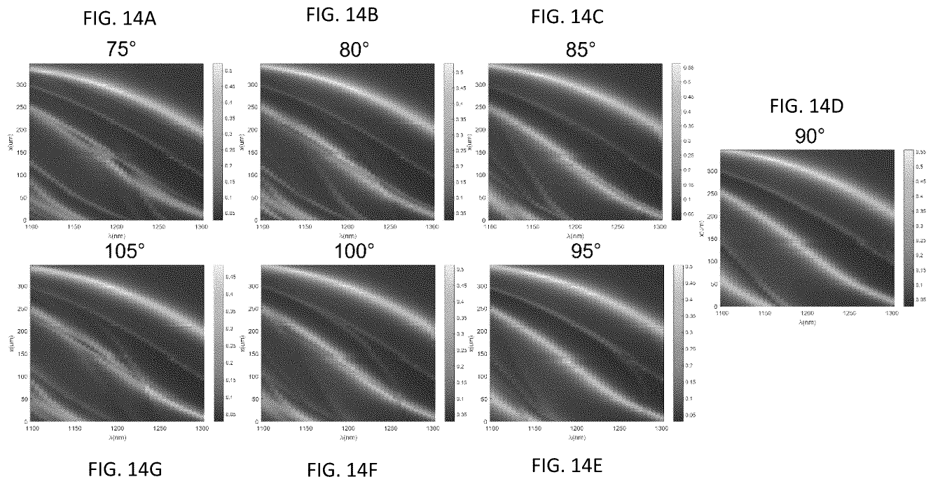

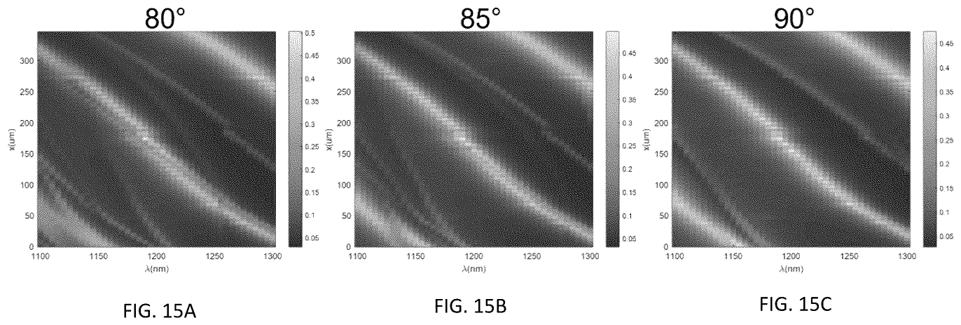

FIGS. 14A-14G show the measured angular response (that is, the response as a function of the incident angle of the optical waveform) of the interferometer of FIG. 13C along the x-coordinate direction (i.e., the direction along which the phase varies), and FIGS. 15A-15C show the measured angular response along the y-coordinate direction (i.e., along which there is no nominal phase gradient). As shown in FIGS. 14A-14G, one of the fringes is blurred when the incident optical waveform is no longer incident at normal angles (90 degrees), although the other fringes remain largely unchanged. A similar observation occurs for the angular response in the y-coordinate direction, indicating that the fabricated interferometers perform similarly when the incident waveform deviates from normal incidence.

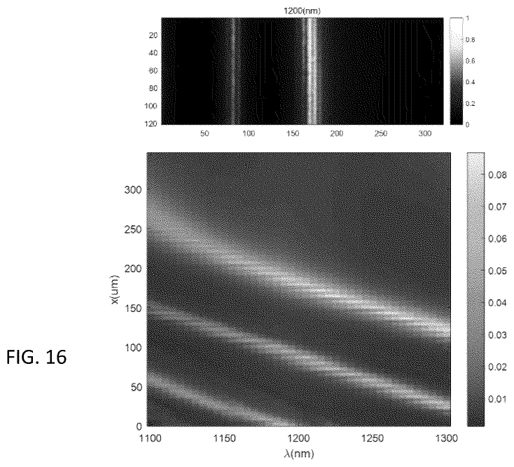

The fringes shown in FIGS. 14A-14G generally appear as curved lines rather than straight lines, suggesting a nonlinear phase variation across the meta-material layer 204. This nonlinear phase variation—which may be attributable to wavelength-dependent contributions to the phase—can be corrected if desired by adjusting the diameters of the pillars along the x-direction of the meta-material layer 204. FIG. 16 is a set of images showing measured fringes from a corrected interferometer. As above, the upper image was obtained at a wavelength of 1.2 μm, while the lower image shows interference fringes measured between 1.1 μm and 1.3 μm. The middle fringe in the lower image is linear within this wavelength range.

As discussed above, the change in phase of imparted by the meta-material layer 204 at a wavelength Σ is generally at least 2π to allow for the constructive interference condition to be realized. In some embodiments, the change in phase can be greater than 2π (e.g., 3π or more, 4π or more, 5π or more, 6π or more, 8π or more, 10π or more, or even more). In certain embodiments, phase changes larger than 2π can be realized by positioning two or more interferometers in a common plane, such that reflected light emerges laterally (i.e., in the x-coordinate direction) from one interferometer and enters an adjacent interferometer from the side. In this configuration, the two interferometers effectively function as a single, extended interferometer that provides a phase gradient greater than the phase gradient of each single interferometer.

In some embodiments, phase changes larger than 2π can be realized by positioning two or more interferometers adjacent to one another and displaced from one another in the z-coordinate direction, so that light emerging from one of the interferometers enters an adjacent interferometer. As above, the overall change in phase imparted by positioning two or more interferometers in this manner can be greater than 2Ξ (e.g., 3Ξ or more, 4Ξ or more, 5Ξ or more, 6Ξ or more, 8Ξ or more, 10Ξ or more, or even more). Whether positioned in a common plane or displaced from one another in the z-coordinate direction, multiple interferometers (e.g., 2 or more, 3 or more, 4 or more, 5 or more, 6 or more, 8 or more, 10 or more, or even more) can be used to realize a phase change greater than 2Ξ. It should be noted that when multiple interferometers are used in a device, the interferometers may have the same configuration, or some or all may have different configurations. For example, the meta-material layers of some or all of the multiple interferometers may differ in any of the properties of these layers described herein.

It should be noted that while the examples described above were designed for operation at a central wavelength of 1.2 μm, the interferometers described herein can generally function (and be designed for operation at) a wide range of wavelengths in the ultraviolet, visible, infrared, and other regions of the spectrum. Within the infrared region of the spectrum, for example, the interferometers can provide a phase shift of 2Ξ or more at wavelengths of between 0.8 μm and 1.8 μm (e.g., at wavelengths between 0.9 μm and 1.7 μm, at wavelengths between 1.0 μm and 1.6 μm, at wavelengths between 1.1 μm and 1.5 μm).

The reflectivity of the partially-reflectively layer(s) (e.g., layer 206) in the interferometers can generally be selected as desired to balance transmitted light intensity and fringe sharpness, as discussed above. In some embodiments, at an operating wavelength Σ, the partially-reflective layer(s) have a reflectivity of between 0.2 and 0.5 (e.g., between 0.25 and 0.35, between 0.25 and 0.45, between 0.3 and 0.4). The interferometers described herein (and particularly, the meta-material layer 204 and the partially-reflective layer 206) effective function as an optical cavity. By adjusting the reflectivity of the partially-reflective layer 206, the finesse of the optical cavity can be controlled. In some embodiments, the finesse of the optical cavity within the interferometer is at least 2 (e.g., at least 3, at least 4, at least 5, at least 7, at least 10, at least 15, at least 20, or even more).

The lateral extent of interferometer 200 is effectively determined by the lateral extent (e.g., in the x-direction) of meta-material layer 204, and more specifically, by the distance over which meta-material layer 204 imparts a phase gradient. In some embodiments, meta-material layer 204 imparts a continuous phase gradient over a distance of at least 1 mm (e.g., at least 1.2 mm, at least 1.4 mm, at least 1.6 mm, at least 1.8 mm, at least 2.0 mm, at least 2.2 mm, at least 2.4 mm, at least 2.6 mm, at least 2.8 mm, at least 3.0 mm, or even more).

In some embodiments, the phase gradient introduced by meta-material layer 204 is a continuous phase gradient. In certain embodiments, the phase gradient may not be perfectly continuous. Where meta-material layer 204 imparts a continuous phase gradient, the continuous phase gradient may be a linear phase gradient. Alternatively, in some embodiments, only a portion of the phase gradient imparted is linear; other portions may be non-linear. In certain embodiments, the imparted phase gradient is entirely nonlinear across meta-material layer 204.

In some embodiments, partially-reflective layer 206 can include a second meta-material layer. Typically, although not always, the second meta-material layer will differ in properties from meta-material layer 204, and may either be in contact with, or spatially separated from, meta-material layer 204. The second meta-material layer can be disposed on a second substrate (e.g., different from substrate 202), with the second substrate positioned so that the two meta-material layers are either in contact or spaced from one another in the z-coordinate direction. If the meta-material layers are spaced such that a gap is located between them, the gap may be at least partially filled with air. Alternatively, or in addition, the gap may be partially or fully filled with one or more additional layers of material. In some embodiments, the additional layer(s) of material function as index matching layers, with an index of refraction that is intermediate between the indices of refraction of the two meta-material layers to reduce spurious reflections within interferometer 200.

In some embodiments, partially-reflective layer 206 does not extend across the entire surface of substrate 202 as shown in FIG. 2A. Instead, partially-reflective layer 206 may extend only partially across substrate 202 in the x-coordinate direction, effectively forming an aperture through which optical waveform 130 can be introduced into interferometer 200. In certain embodiments, meta-material layer 204 also may not extend under the aperture to allow for the introduction of optical waveform 130.

In certain embodiments, interferometer 200 may include one or more fiducial markers to facilitate alignment of the interferometer in an optical system. Fiducial markers can generally take a wide variety of forms, including crosses, triangles, circles, and other geometric shapes. Fiducial markers can be applied by etching, lithography, and more generally, any other technique compatible with the fabrication process described herein. Fiducial markers can be applied to any one or more of substrate 202 and layers 204, 206, 208, and 210.

As discussed above, meta-material layer 204 is typically fabricated as a plurality of repeating structures on substrate 202. The structures can be formed of a wide variety of materials including, but not limited to, Si and TiO₂. In general, any optical material with suitable refractive index properties can be used for the repeating structures.

The repeating structures can be implemented in a wide variety of shapes. In some embodiments, the structures are cylindrical in shape. In certain embodiments, the structures are prismatic in shape (e.g., square prismatic, rectangular prismatic, or any other geometric prismatic shape, such as pentagonal prismatic, hexagonal prismatic, and octagonal prismatic).

In some embodiments, the structures are positioned in the meta-material layer 204 in a regular array, within spacings between adjacent structures uniform in both the x- and y-directions. In certain embodiments, spacings are uniform in the x-direction and in the y-direction, but the uniform spacing in the x-direction differs from the uniform spacing in the y-direction. In some embodiments, the spacings between some of the structures in either or both of the x- and y-directions varies. As discussed above, to correct for wavelength-dependent phase contributions, the spacings between at least some structures in the x-direction can vary.

In general, the structures can have uniform heights in the z-direction, or some of the structures may have different heights than others. In some embodiments, an average height of the structures in the z-direction is between 0.2 μm and 1.5 mm (e.g., between 0.5 μm and 1.3 mm, between 0.5 μm and 1.0 mm, between 0.7 μm and 1.1 mm, and/or any other range between 0.2 μm and 1.5 mm).

The cross-sectional dimensions of the structures can generally be adjusted to control the reflectivity of meta-material layer 204. The cross-sectional dimensions and shapes of the structures can be the same in some embodiments, or alternatively, in certain embodiments, at least some of the structures may have cross-sectional shapes and/or dimensions that differ from other structures. In some embodiments, for example, an average maximum cross-sectional dimension of the structures is between 50 nm and 1 mm (e.g., between 100 nm and 800 μm, between 200 nm and 500 μm, between 200 nm and 100 μm, between 200 nm and 1 μm, between 200 nm and 900 nm, between 200 nm and 800 nm, between 200 nm and 700 nm, between 200 nm and 600 nm, between 200 nm and 500 nm, and any other range between 50 nm and 1 mm).

The structures can generally be formed from a material with any desired index of refraction, although commonly the index of refraction of the structures is higher than the index of refraction of substrate 202. In some embodiments, for example, the index of refraction of the material forming the structures is between 3.0 and 4.0.

In certain embodiments, the structures of meta-material layer 204 are embedded within a second material, which may have a lower index of refraction. For example, in some of the examples described above, the structures were embedded in PMMA. More generally, a wide variety of embedding materials may be used, including (but not limited to) polymer materials such as PMMS, PDMS, polycarbonates, polyacrylics, polystyrenes, polyesters, cylic olefin polymers (COPs), and fluoropolymers such as CYTOP, and non-polymer materials such as glass, fused silica, quartz, and sapphire.

When the structures are embedded in second material within meta-material layer 204, the second material can, in some embodiments, have an index of refraction and the operating wavelength Σ of between 1.0 and 2.0. A difference in the indices of refraction between the structures and the second material in some embodiments is between 1.5 and 2.5 (e.g., between 1.7 and 2.3, between 1.8 and 2.2, or any other range between 1.5 and 2.5).

In some embodiments, meta-material layer 204 can include multiple pluralities of repeating structures, where each plurality of repeating structures can have any of the properties described herein, and where each plurality of repeating structures differs from the other pluralities of repeating structures in at least one property. Such properties by which the pluralities of repeating structures differ can be, for example, shapes, cross-sectional dimensions, heights, materials from which the repeating structures are fabricated, and spacings between adjacent structures in each plurality of structures.

### III. Meta-Material Optical Devices and Systems

Optical devices and systems that feature the interferometers described herein can also include other meta-material-based optical elements to provide additional functionality that is not available in conventional optical systems.

In a conventional optical spectrometer, the wavelength components of an optical waveform are distributed spatially by a dispersive element such as a grating or prism, and a detector is positioned to measure the components. For a pixel-based detector such as a CCD, wavelength is effectively mapped to pixel location, which allows spectral intensities at specific wavelengths to be determined. However, in conventional spectrometers, wavelength components are dispersed along a single spatial dimension, and therefore the number of resolvable wavelengths is limited to the number of available detector elements along that dimension.

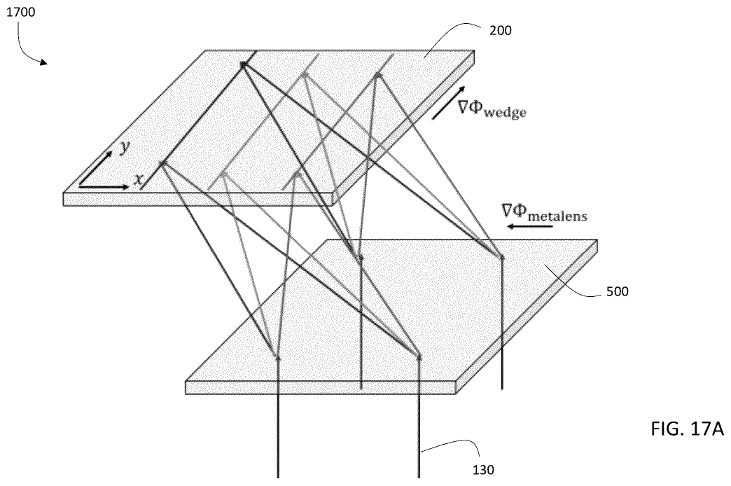

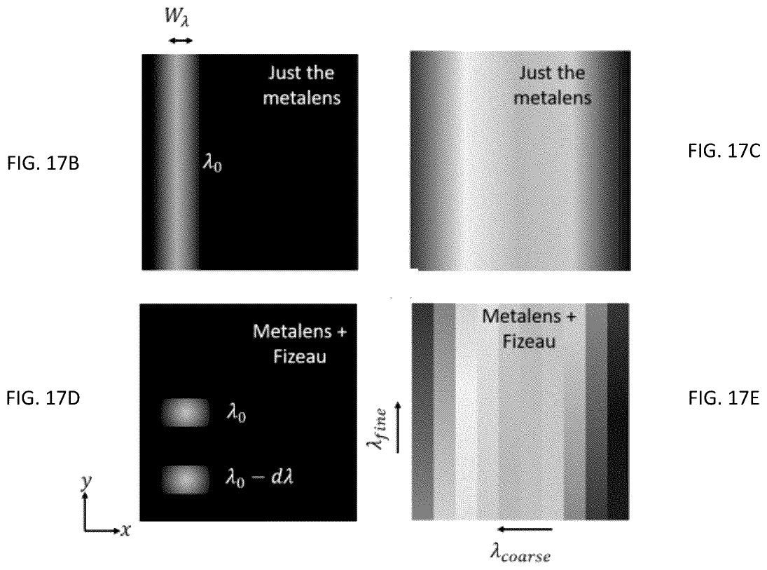

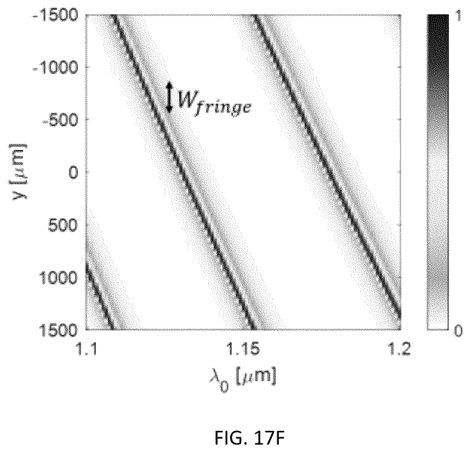

The number of resolvable wavelengths can be increased by resolving wavelengths along both spatial dimensions of a two-dimensional detector, without changing the detector's dimensions. FIG. 17A shows a schematic diagram of an optical device 1700 that includes an interferometer 200 as described herein and a meta-material lens 500. These two elements together function to increase wavelength resolution by a pixel-based detector.

Lens 500 is generally fabricated as described herein in connection with interferometer, except that at least one of the outer surfaces of lens 500 is curved. In FIG. 17A, lens 500 is implemented as a cylindrical lens, with curvature along the x-direction—the same direction along which the lens imparts a phase gradient via a meta-material layer within the lens. An optical waveform 130 is incident on lens 500 and is dispersed spatially along the x-direction, with each wavelength component in waveform 130 focused to a line extending along the y-direction by lens 500.

The dispersed, focused wavelength components are then incident on interferometer 200, which is oriented such that the phase change it imparts occurs along the y-coordinate direction. In this manner, each of the line-focused wavelength components is further dispersed spatially along the y-direction, providing for additional wavelength resolution within each spectral component.

The effect of the combination of interferometer 200 and lens 500 is to significantly increase the number of wavelengths that can be independently measured by a pixel-based detector positioned to receive the spatially separated wavelength components from interferometer 200.

FIGS. 17B and 17C are graphs showing the effect of lens 500 alone. For an optical waveform consisting of a single wavelength Σ₀ as shown in FIG. 17B, lens 500 focuses the light to a single line that extends along the y-direction. For an optical waveform consisting of multiple wavelength components as shown in FIG. 17C, lens 500 disperses the components along the x-direction, and focuses each dispersed component to a line extending along the y-direction.

FIGS. 17D and 17E are graphs showing the effect of the combination of lens 500 and interferometer 200. In FIG. 17D, spectral contributions at wavelengths Σ₀-fΣ, where fΣ<<Σ₀, are separated from spectral contributions at Σ₀ by the phase gradient imparted by interferometer 200 along the y-direction. For an optical waveform 130 that includes multiple wavelength components as shown in FIG. 17E, each component focused to a line extending along the y-direction is further dispersed spatially by interferometer 200, allowing for wavelength resolution along both x- and y-directions of the pixel-based detector.

FIG. 17F is a graph showing the transmittance map of device 1700. The map was calculated assuming d=10 μm and r²=0.85. The fringe length along the y-direction is approximately 50 μm. Assuming a pixel-based detector with a length of 3 mm along the y-direction, the number of resolved wavelengths increases by a factor of 3 mm/50 μm=60, relative to a device without interferometer 200.

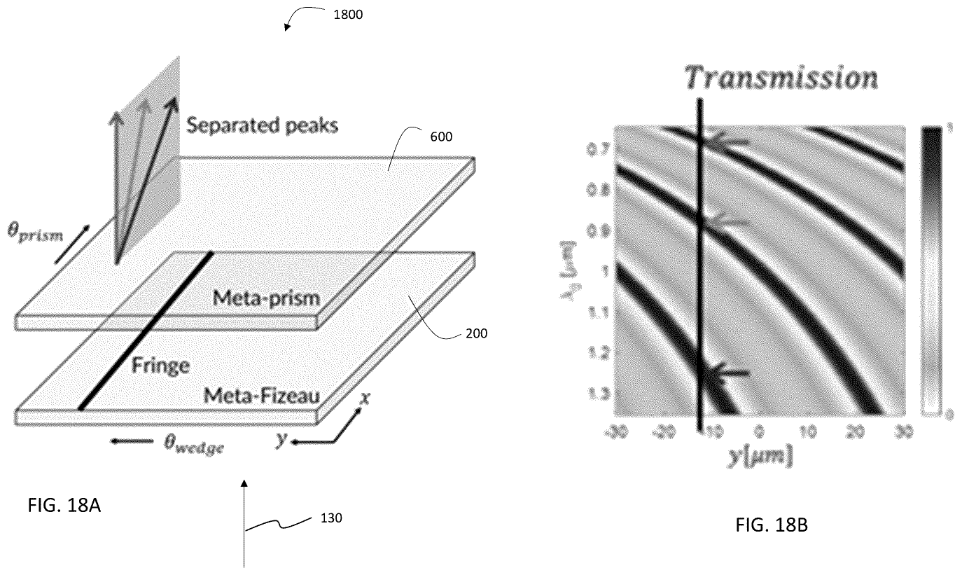

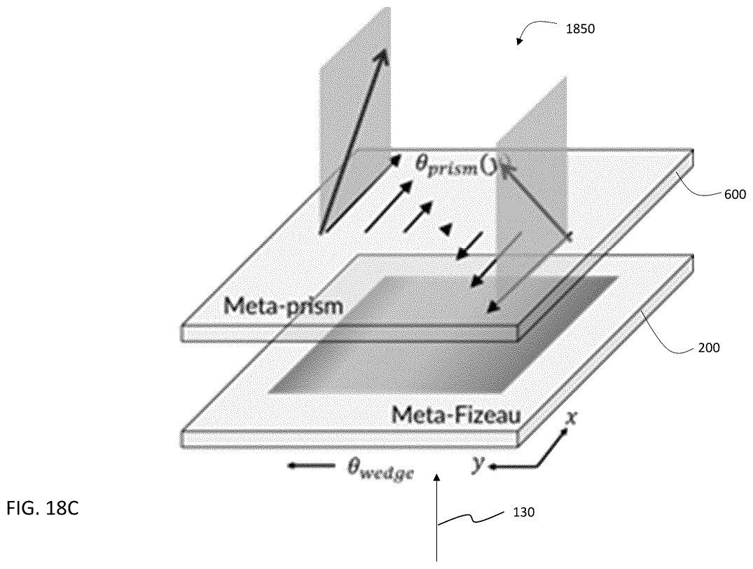

Another example of a meta-material-based optical system is shown in FIG. 18A. System 1800 includes an interferometer 200 as described herein, along with a meta-material-based prism 600. Prism 600 consists of a substrate with a meta-material layer 204 fabricated atop the surface. The meta-material layer of prism 600 can generally have any of the properties of the meta-material layers described herein, and can be fabricated using methods similar to those described herein.

In general, the meta-material layer of prism 600 imparts a nominally linear phase gradient to light that is incident on the prism. When prism 600 is combined with interferometer 200, system 1800 separates incident light in a manner that is not possible using either element individually. Referring to FIG. 18A, an optical waveform 130 is incident on interferometer 200, which is oriented such that the phase gradient imparted by interferometer is along the y-direction, leading to dispersion of the wavelength components of optical waveform 130 along the y-direction. FIG. 18B is a graph showing an example transmission spectrum of interferometer 200, which is designed to generate three peaks within a free spectral range operating bandwidth (identified with arrows in FIG. 18B). Returning to FIG. 18A, these three peak are then separated along the x-direction by the phase imparted by prism 600. This extends the operating range of interferometer 200 beyond a single free spectral range.

A further example of an optical system 1850 is shown in FIG. 18C. System 1850 includes both an interferometer 200 and prism 600 as in FIG. 18A. However, in FIG. 18C, the magnitude and direction of the phase imparted by prism 600 varies in the x-direction. As a result, separated wavelength components generated by interferometer 200 from incident optical waveform 130 are deflected by varying angles and positions in the x-direction. Consequently, system 1850 allows distinct wavelength components within a single free spectral range of interferometer 200 to be measured and controlled. For example, by selecting an appropriate variable phase for the meta-material layer of prism 600, the wavelength components incident on prism 600 can be significantly separated spatially along the x-direction in the far field of prism 600, thereby effectively magnifying the output of interferometer 200.

### OTHER EMBODIMENTS

While this disclosure describes specific implementations, these should not be construed as limitations on the scope of the disclosure, but rather as descriptions of features in certain embodiments. Features that are described in the context of separate embodiments can also generally be implemented in combination in a single embodiment. Conversely, various features that are described in the context of a single embodiment can also be implemented in multiple embodiments separately or in any suitable sub-combination. Moreover, although features may be described above as present in certain combinations and even initially claimed as such, one or more features from a claimed combination can generally be excised from the combination, and the claimed combination may be directed to a sub-combination or variation of a sub-combination.

In addition to the embodiments expressly disclosed herein, it will be understood that various modifications to the embodiments described may be made without departing from the spirit and scope of the disclosure. Accordingly, other embodiments are within the scope of the following claims.

1. An optical system, comprising:
a first optical element comprising:
a first substrate;
a partially-reflective coating disposed on a first surface of the first substrate;
a first meta-material layer positioned on or adjacent to a first surface of the first substrate and comprising a structure that defines a continuous phase gradient along a first direction parallel to the first surface of the first substrate, wherein a change in magnitude of the phase along the first direction is at least 2π at a wavelength λ; and
a partially-reflective layer disposed on or adjacent to the first meta-material layer and on an opposite side of the meta-material layer from the first substrate; and
a second optical element comprising:
a second substrate; and
a second meta-material layer positioned on or adjacent to a first surface of the second substrate and comprising a structure that defines a continuous phase gradient along a second direction parallel to the first surface of the first substrate,
wherein the first and second optical elements are oriented so that the first and second directions are approximately orthogonal; and
wherein at least one surface of the second optical element is curved along the second direction.

2. The optical system of claim 1, wherein the change in magnitude of the phase along the first direction is at least 2π at a wavelength λ of between 0.8 μm and 1.8 μm.

3-4. (canceled)

5. The optical system of claim 1, wherein the partially-reflective coating has a reflectivity of between 20% and 50% at the wavelength λ.

6. (canceled)

7. The optical system of claim 1, wherein the continuous phase gradient along the first direction extends for a distance of at least 1 mm along the first direction.

8-9. (canceled)

10. The optical system of claim 1, wherein at least a portion of the continuous phase gradient along the first direction is a linear phase gradient.

11. The optical system of claim 1, wherein the partially-reflective layer is a coating disposed on a surface of the first meta-material layer.

12. The optical system of claim 1, wherein the partially-reflective layer comprises a third meta-material layer different from the first meta-material layer.

13. (canceled)

14. The optical system of claim 12, wherein the third meta-material layer is disposed on a third substrate different from the first substrate.

15. The optical system of claim 14, wherein the third substrate is positioned relative to the first substrate such that the first and third meta-material layers are in contact.

16. The optical system of claim 14, wherein the third substrate is positioned relative to the first substrate such that a gap is located between the first and third meta-material layers.

17. (canceled)

18. The optical system of claim 16, wherein at least one additional layer is positioned in the gap, and wherein the at least one additional layer comprises a solid material.

19. (canceled)

20. The optical system of claim 18, wherein the at least one additional layer comprises an index matching layer with an index of refraction at the wavelength λ that is between an index of refraction of the first meta-material layer at the wavelength λ and an index of refraction of the third meta-material layer at the wavelength λ.

21-22. (canceled)

23. The optical system of claim 1, wherein the partially-reflective coating, the first meta-material layer, and the partially-reflective layer define an optical cavity.

24-27. (canceled)

28. The optical system of claim 1, wherein the first meta-material layer is positioned on or adjacent to a first region of the first surface of the first substrate, and wherein an aperture that is free of the first meta-material layer is positioned on or adjacent to a second region of the first surface of the first substrate, wherein the first and second regions of the first surface of the first substrate do not overlap.

29-31. (canceled)

32. The optical system of claim 1, wherein the first meta-material layer comprises a plurality of repeating structures formed of a first material and embedded in a second material.

33. The optical system of claim 32, wherein the first material comprises at least one member selected from the group consisting of Si and TiO₂.

34. (canceled)

35. The optical system of claim 32, wherein the plurality of repeating structures comprise cylindrical structures.

36. The optical system of claim 32, wherein the plurality of repeating structures comprise rectangular prismatic structures.

37. The optical system of claim 32, wherein an average height of the repeating structures in the first meta-material layer, measured in a direction orthogonal to the first surface of the first substrate, is between 0.2 μm and 1.5 mm.

38. (canceled)

39. The optical system of claim 32, wherein an average maximum cross-sectional dimension of the repeating structures in the first meta-material layer, measured in a direction parallel to the first surface of the first substrate, is between 50 nm and 1 mm.

40. (canceled)

41. The optical system of claim 32, wherein an index of refraction at the wavelength λ of the first material is between 3.0 and 4.0, and wherein an index of refraction at the wavelength λ of the second material is between 1.0 and 2.0.

42. (canceled)

43. The optical system of claim 32, wherein a difference between indices of refraction of the first and second materials at the wavelength λ is between 1.5 and 2.5.

44. The optical system of claim 32, wherein the second material comprises at least one material selected from the group consisting of glass, fused silica, quartz, sapphire, and a polymer material.

45-46. (canceled)

47. The optical system of claim 32, wherein the plurality of repeating structures are a first plurality of repeating structures and the first meta-material layer further comprises a second plurality of repeating structures formed of the first material and embedded in the second material, and wherein the second plurality of repeating structures are different from the first plurality of repeating structures.

48. The optical system of claim 47, wherein the second plurality of repeating structures have a different cross-sectional shape than the first plurality of repeating structures.

49. The optical system of claim 47, wherein an average height of the second plurality of repeating structures, measured in a direction orthogonal to the first surface of the first substrate, differs from an average height of the first plurality of repeating structures measured in the direction orthogonal to the first direction.

50. The optical system of claim 47, wherein an average maximum dimension of the second plurality of repeating structures, measured in a direction parallel to the first surface of the first substrate, differs from an average maximum dimension of the first plurality of repeating structures measured in the direction parallel to the first surface of the first substrate.

51. The optical system of claim 32, wherein the first meta-material layer further comprises a plurality of repeating structures formed of a third material and embedded in the second material, and wherein the third material is different from the first material.

52-58. (canceled)

59. The optical system of claim 1, wherein the second optical element is a lens.

60. The optical system of claim 59, wherein the second optical element is a cylindrical lens.

61. The optical system of claim 59, wherein the second optical element is a lens selected from the group consisting of a plano-convex lens, a plano-concave lens, a biconvex lens, a biconcave lens, and a convex-concave lens.

62. The optical system of claim 59, wherein the second optical element is a transmissive lens.

63. The optical system of claim 59, wherein the second optical element is a reflective lens.

64. The optical system of claim 1, wherein the at least one surface of the second optical element is curved along both the first and second directions.

65. The optical system of claim 1, wherein a curvature of the at least one surface of the second optical element along the second direction is aspherical.

66. The optical system of claim 1, wherein a curvature of the at least one surface of the second optical element along the second direction is selected from the group consisting of at least partially spherical and at least partially parabolic.

67-70. (canceled)

71. The optical system of claim 64, wherein a curvature of the at least one surface of the second optical element along the first direction differs from a curvature of the at least one surface of the second optical element along the second direction.

72. The optical system of claim 1, wherein the change in magnitude of the phase along the second direction is at least 2π at a wavelength λ of between 0.8 μm and 1.8 μm.

73-104. (canceled)

105. A device, comprising:
the optical system of claim 1,
wherein the optical system comprises a plurality of first optical elements;
wherein the first surface of the first substrate of each first optical element is positioned in a common plane so that the partially-reflective coatings, the first meta-material layers, and the partially-reflective layers of each first optical element collectively define a continuous optical cavity that extends in a direction parallel to the common plane; and
wherein a change in magnitude of the phase along the continuous optical cavity is greater than 2π at the wavelength λ.

106-107. (canceled)

108. The device of claim 105, wherein one or more of the plurality of first optical elements differs from one or more others of the plurality of first optical elements.

109. (canceled)

110. The device of claim 108, wherein the change in magnitude of the phase along the first direction for one or more of the plurality of first optical elements differs from the change in magnitude of the phase along the first direction for one or more others of the plurality of first optical elements.

111. (canceled)

112. A device, comprising:
the optical system of claim 1,
wherein the optical system comprises a plurality of first optical elements;
wherein the first surface of the first substrate of one or more of the plurality of first optical elements is displaced in a direction orthogonal to the first surface of the first substrate from the first surface of the first substrate of one or more others of the plurality of first optical elements so that the partially-reflective coatings, the meta-material layers, and the partially-reflective layers of the plurality of first optical elements define a plurality of optical cavities that are mutually displaced in the orthogonal direction; and
wherein a collective change in magnitude of the phase among the optical cavities is greater than 2π at the wavelength λ.

113. The device of claim 112, wherein the first surfaces of the first substrates of at least some of the plurality of first optical elements are positioned in a common plane so that the partially-reflective coatings, the meta-material layers, and the partially-reflective layers of the at least some of the plurality of first optical elements collectively define a continuous optical cavity that extends in a direction parallel to the common plane.

114. The device of claim 113, wherein the device comprises multiple continuous optical cavities each extending in a different plane, and wherein each continuous optical cavity is mutually displaced from other continuous optical cavities in the device.

115-116. (canceled)

117. The device of claim 112, wherein one or more of the plurality of first optical elements differs from one or more others of the plurality of first optical elements.

118. The device of claim 117, wherein the meta-material layer of one or more of the plurality of first optical elements differs from the meta-material layer of one or more others of the plurality of first optical elements.

119-123. (canceled)
